(19) United States
(12) Patent Application Publication
(10) Pub. No.: US 2010/0033573 A1
(43) Pub. Date: Feb. 11, 2010

(54) MOBILE SYSTEM AND METHOD FOR REMOTE CONTROL AND VIEWING

(75) Inventors: Dimitar Malinovski, Sofia (BG); George Georgiev, Sofia (BG); Georgi Aleksandrov, Kyustendil (BG)

Correspondence Address: CANTOR COLBURN, LLP, 20 Church Street, 22nd Floor, Hartford, CT, 06103, US

(73) Assignee: SECURITY AGENCY SIGMA JSC, Sofia (BG)

(21) Appl. No.: 12/526,848

(22) PCT Filed: Feb. 20, 2007
(86) PCT No.: PCT/BG07/00002

§ 371 Date: Aug. 12, 2009

(30) Foreign Application Priority Data
Feb. 15, 2007 (BG) 109820

(51) Int. Cl. H04N 7/18; H04M 3/00

(52) U.S. Cl. 348/158; 455/420; 348/E07.085

(57) ABSTRACT

The present invention relates to a method and a system with increased security for remote monitoring and mobile remote control of objects. The mobile system consists of at least one local system for monitoring (4), communication devices (8) for data transfer between at least one monitoring object (11) and at least one monitored object (12) and connection system (1). The connection system (1) is one private computer (2) and cellular (3) network of a mobile operator, which is capable of registering Access Point Name and has Dynamic Host Configuration Protocol (DHCP) server with capability for reservation of static IP addresses. A method is discovered where controlled devices for communication and controlling devices for communication are connected to a private computer and cellular network of a single mobile operator.

### FIELD OF THE INVENTION

The present invention relates to the field of mobile data communications in general. More specifically, the present invention describes a method and system with increased security for remote monitoring and mobile remote control of entities. It could find application with security activities for monitoring and fast reaction in case of emergencies in remote entities such as: banks, offices, all kinds of vehicles (including standing or in motion), warehouses, secured areas and others, as well as for individually organized monitoring, for example of houses, garages etc.

### BACKGROUND OF THE INVENTION

Initially the systems for video monitoring in security activities are fixed and static. As a result of the fast development of digital technology, computers were added to these systems, which made them easier to control and with greater functionality, but only within the framework of one local area computer network. With the advent of the global computer network (Internet), these systems got the ability to connect to that network and thus got mobility in the case of remote monitoring and control. Such systems are described in many patents, such as EP1317144, U.S. Pat. No. 7,155,518, JP2002064810, JP2004289669, TW250746, WO2005064943 etc. These are mobile systems for remote control of entities comprising connection system including the network of at least one mobile operator, local computer system for monitoring, connected to the linked system, and communication devices for data transmission between at least one monitoring object and at least one monitored object also linked to the connection system. The local monitoring system includes at least one video camera for monitoring of entity with capabilities for control and/or to be configured through a computer, as well as at least one computer connected to the video camera, and communication devices include control devices for communications with the monitoring object and controlled devices for communication with monitored object. The control devices for communications are connected to the network of the mobile operator. These systems for mobile video monitoring always use in at least one of the points of the public Internet network, with at least one public IP address.

All such systems are easy to implement technically, but their use for security systems is with reduced reliability, due to the following. The use of public IP addresses allows for attacks and unauthorized access to the monitored objects, since there is a possibility of hidden from the authorized party parallel monitoring. In addition to that, if in the intermediate point of transmission of the TCP/IP packets with data from the video monitoring in the Internet network these packets are captured, than it is easy, just by changing the destination IP address, to redirect the entire information from the video monitoring to an unauthorized user, at that without the need of an attack of the point of video monitoring in order to find out the name and password of the authorized user. Since the controlling device for communication of the monitoring object is a mobile device, it uses a private IP address from the mobile operator to which it is linked. In order to reach to the public IP address of the Internet network are used NAT (Network Address Translation) and Proxy servers of the mobile operator. In addition, since every time when the mobile device connects it gets a different IP address, it is not possible to use the additional capabilities of the monitoring systems with the so called white lists, which are lists of IP addresses that are authorized for remote monitoring. The known systems are open for DoS (Denial of Service) attack. When there is such an attack on the computer system for video monitoring, both the remote monitoring as well as the remote control could be completely blocked, since for the duration of the attack the system is not accessible via Internet. Thus it is possible intentionally to block the system for remote control and monitoring for a certain period of time, which makes the system unreliable. Another disadvantage of the known mobile systems for remote control is that, when using Internet through a mobile operator and another Internet provider, the entire network could not be administered centrally from a single point and thus it is not possible to apply a unified policy for the quality of the communication line—Quality of Service (QoS Packet Scheduler). This is particularly important to ensure uniform video flow. The lack of this service leads to significant reduction of the quality of transmission that leads to interruptions and loss of movement during monitoring through Internet, which in all cases is undesirable.

In the described in TW250746 method for remote control of objects is made an attempt to improve the security of the mobile monitoring by building at each monitored object of a Virtual Private Network (VPN) link. These method and a system are not flexible and do not reduce significantly the above problems, since the customer is dependent on the mobile operator, which has to change the settings at every change on the location of the entities under surveillance. Furthermore in this case as well the monitoring point also has to be connected to the Internet, where for establishing of VPN it is necessary to encrypt the entire traffic from a server of the mobile operator to the VPN server next to the system for video monitoring. However the VPN server at the point of monitoring remains open for Internet attacks, including for DoS attacks. VPN implements encryption of the entire traffic, which with video monitoring is rather large, the encryption/decryption requires significant memory and processing power from the mobile phones, which in the case of stream video as in the case of real time monitoring leads to significant reduction of quality—from interruption of the images to single frames. Since the use of Internet by the mobile devices is via NAT or the Proxy servers of the mobile operator, one could never use the most reliable protocol for VPN-L2TP (Layer 2 Tunneling Protocol) and the only possibility remains the use of PPTP (Point-to-Point Tunneling Protocol) protocol, which is not sufficiently reliable.

The systems, which include the use of Internet practically compromise the safety of the video monitoring aiming at security activities, as a result these systems could be applied only when the safety of video monitoring is irrelevant.

### SUMMARY OF THE INVENTION

The problem solved by the present invention is to provide a method and mobile system for remote monitoring of objects, which ensure reliable protection to the transmitted in real time data, while maintaining high quality of the signal.

This and other problems are solved by a mobile system for remote control and viewing of objects, comprising a connection system, at least one local system for monitoring, and communication devices for data transmission between at least one monitoring object and at least one monitored object. In this case the connection system is from one private computer and cellular system of a mobile operator, having possibility for registration of Access Point Name (APN) and having a Dynamic Host Configuration Protocol (DHCP) server capable to reserve static IP addresses. Each local computer system for monitoring includes at least one video camera for monitoring, which can be controlled and/or configured with a computer, as well as at least one computer connected to the video camera. The communication devices are at least two mobile devices with SIM cards, capable of operating at a speed of at least 84 Kbps, where one of the mobile devices is controlling device for communications at the monitoring object, while the other mobile device is controlled device for communication at the monitored object. At least one of the mobile devices is connected to at least one computer for video camera at monitored object and at least one of the mobile devices is capable to receive data from a mobile device, connected to the computer of a video camera at the monitored object.

The mobile system of this invention is extremely reliable, since the connection system is one and it is the private computer and cellular network of the mobile operator. In this network the mobile operator could apply QoS policy for ensuring of uniform video flow. The use only of a mobile operator, without its links to the Internet increases significantly the security of data flow, as it allows for protection, which is extremely difficult to overcome by a unauthorized user. These advantages of the system of the invention make it particularly suitable for security applications. The link to the network of the mobile operator of the local computer system for monitoring could be permanent (24 hours×7 days a week), thus the monitoring system is always accessible from any mobile point of the monitoring object. This does not make the using of the system costlier, since the charges for data are based on traffic and not on time, thus the monitoring party pays only for the quantity of data transmitted through the network of the mobile operator, regardless of the period of time during which the network has been used.

In one embodiment of the mobile system for remote control of objects according to the present invention, at least one of the mobile devices with SIM card is a mobile smart phone. Such system ensures mobile remote monitoring, including while in motion.

In another embodiment of the invention the mobile control device of at least one of the monitoring objects is connected to a computer. This provides the opportunity to store the audio and/or video information in a remote from the monitored object location. In one preferred embodiment the computer is portable, which provides for mobility of the system.

In another embodiment of the mobile system according to the invention, at least one controlled mobile device is connected to at least two computers of video cameras installed at monitored objects. This allows the possibility to set up a common monitoring and control center, which could be mobile.

In another embodiment of the invention, at least one camera for monitoring is installed in a vehicle. Thus, the local system for monitoring and the monitored object are mobile. In this way the system becomes particularly suitable for continuous monitoring when protecting shipments, people and valuables.

In the next embodiment of the mobile system of the invention, between the communications devices a VPN (Virtual Private Network) link is established. This additionally increases the security of the system.

It is preferable that a microphone is mounted in at least one local monitoring system. Thus it is possible to realize video and audio data transfer. Most preferably the microphone is built-in the video camera.

In another embodiment of the mobile system at least one mobile device at the monitoring object is capable of storing data and/or it is capable for remote control of data storage in at least one local monitoring system. This helps to create a reliable backup copy of the data outside the monitored object, which could be target of a terrorist attack.

In yet another embodiment of the invention the video camera is built-in a computer.

This invention relates to a method for remote control of objects as well, where controlled communication devices and controlling communication devices connected to a private computer and cellular network of one mobile phone operator. The method comprises installing and configuring of application software in the controlled by a local computer system for audio and/or video monitoring devices for communication. The application software provides for local and remote audio and/or video monitoring of at least one monitored object. The method comprises also of steps for registering with a mobile operator of an Access Point Name (APN) of a private network for wireless access, connecting of controlling devices for communication to the network of the mobile operator, and activating with the mobile operator of at least two SIM cards for data transfer, registering the activated SIM cards for use with the registered APN, defining static private IP addresses for each SIM card registered with APN, reserving with the Dynamic Host Configuration Protocol (DHCP) server of the mobile operator the defined IP addresses, placing each SIM card in one mobile device, and creating a profile with settings to connect to the registered APN. In addition the method comprises also of connecting to at least one local system for monitoring of a controlled mobile device for communications, as well as setting of the system and application software of the local system for monitoring through wireless connection to the private APN network of the mobile operator. Data transfer is implemented between the controlled devices for communication at the monitored object and the controlling devices for communication of the controlling object, as well as real time remote monitoring and control of the monitored object. The method ensures security of the remote monitoring and remote control, while the entire communication remains enclosed within the private computer and cellular network of one mobile operator. Every registered customer will get fixed private IP addresses for its SIM cards and communication will be allowed only between the registered IP addresses of one customer. Thus, it will not be possible one customer to enter in the system of another customer. It is not possible to place an intermediate point to record the packets with video information with the aim of their remake at a later time. In addition, the mobile operator enforces certain policy for encryption of the entire traffic, and in that case it could successfully enforce a policy of prioritizing of this traffic—QoS Packet Scheduler, and thus avoid interrupts and/or loss of movement during video monitoring. The method according to the invention allows for building systems capable of mobile monitoring and control, which are accessible all the time, while the customer pays only for the actual quantity of data transferred via the network of the mobile operator. The method allows for changes in the position of the points of monitoring without the requirement of any modifications in the settings. It is important to note that the method allows for control of the staff, which is monitoring systems for video monitoring.

In one embodiment of the method according to the invention, the mobile operator registers the APN name with at least one other mobile operator, with which it has a roaming agreement. Thus it becomes practical to control and monitor objects that are situated very fare from each other.

In yet another embodiment of the method according to the invention, in the application software of the local monitoring system is created a “white list” which includes all private IP addresses, which are authorized for audio and/or video monitoring and control of the monitored object. This embodiment improves significantly the security through additional access control.

It is preferable that the local computer system for monitoring is connected to the network of the mobile operator at all times, thus allowing uninterrupted local and remote audio and/or video monitoring.

In one another embodiment of the method, the local computer system notifies the control devices of at least one controlling object about event defined in advance in the application software.

### BRIEF DESCRIPTION OF THE DRAWINGS

FIG. 1 shows a block diagram of the mobile system according to the invention;

FIG. 2 is a diagram of the mobile system, where the mobile device at the monitoring object is a mobile smart phone;

FIG. 3 is a diagram of the mobile system, where the mobile device at the monitoring object is connected to a computer capable of storing data;

FIG. 4 is a diagram of the mobile system, where more than one local system for monitoring is connected to one mobile device;

FIG. 5 shows a diagram of the mobile system, where the local system for monitoring is installed in a vehicle;

FIGS. 6a-b shows diagrams of local monitoring systems according to the invention;

FIG. 7 shows a diagram of a mobile system, which is using more than one mobile operator;

FIG. 8 shows different embodiments of VPN links;

FIG. 9 shows an algorithm of the steps of the method for remote control of objects according to the invention.

### DETAILED DESCRIPTION OF THE INVENTION

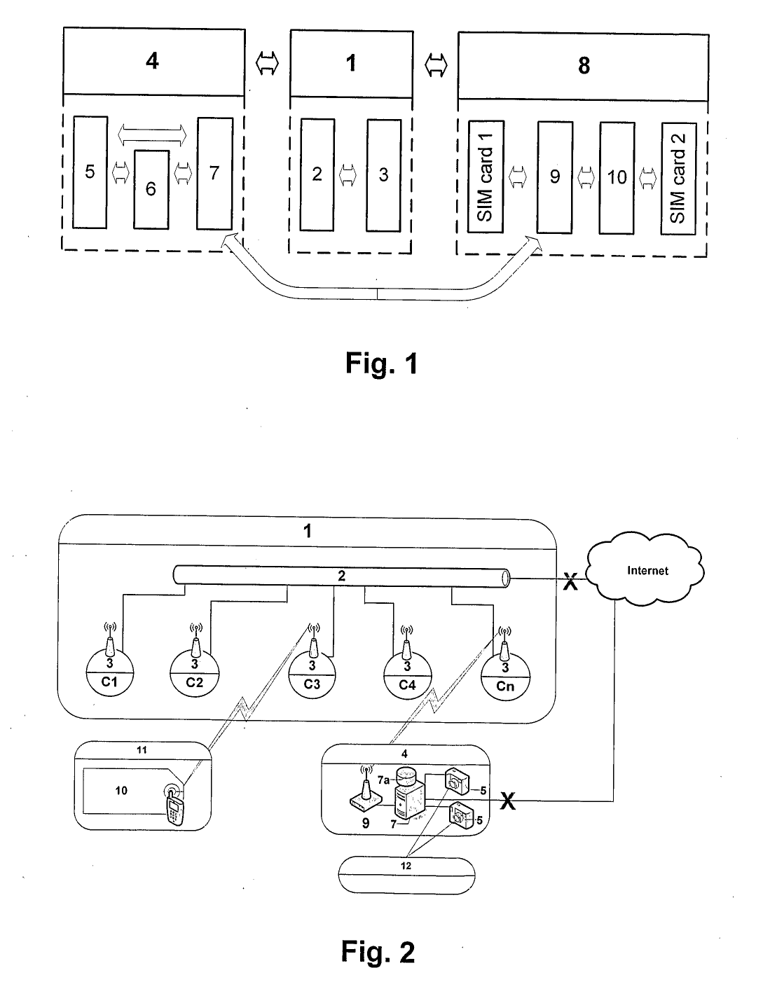

FIG. 1 illustrates the mobile system of the invention as a block diagram. The mobile system includes a connection system 1, which represents the network in this case a mobile operator, consisting of a private computer network 2 and a cellular net 3. To the connection system 1 is linked, in this case, a local system for monitoring 4. It consists of at least one video camera 5 for monitoring objects. The video camera 5, in shown embodiment is with its own control system 6. Besides that, the video camera 5 in this case is connected to the computer system 7 as well. This provides for local as well as remote control of the camera 5. The presence of the computer system 7 allows not only video monitoring but also control of the data storage. To the connection system 1 are linked the communication devices 8 as well. In FIG. 1 are shown two mobile devices for communication 8, where one of them is a controlled device for communication 9 and is linked in to the computer system 7 of the local system for monitoring 4. The other is controlling device for communication 10 and through it a mobile monitoring and control is implemented of the monitored object. The connection between the two communication devices 9 and 10 is through the connection system 1. The communication devices 9 and 10 have SIM cards, activated for data in a private APN of a mobile operator.

FIG. 2 represents an example of a mobile system, according to the invention, where the controlling device for communication 10 is a mobile smart telephone, wherein is situated at the monitoring object 11. The local monitoring system 4 is localized in the monitored object 12. As a controlling device 10 could be used all available on the market high-speed mobile devices, for example operating according to the following standards: GPRS, EDGE, UMTS and HSDPA. The system of this invention is tested with a Siemens MC35i Terminal, VMCC and VMCM. The private computer network 2 of the mobile operator and the computer system 7 of the local system 4 are not connected to Internet.

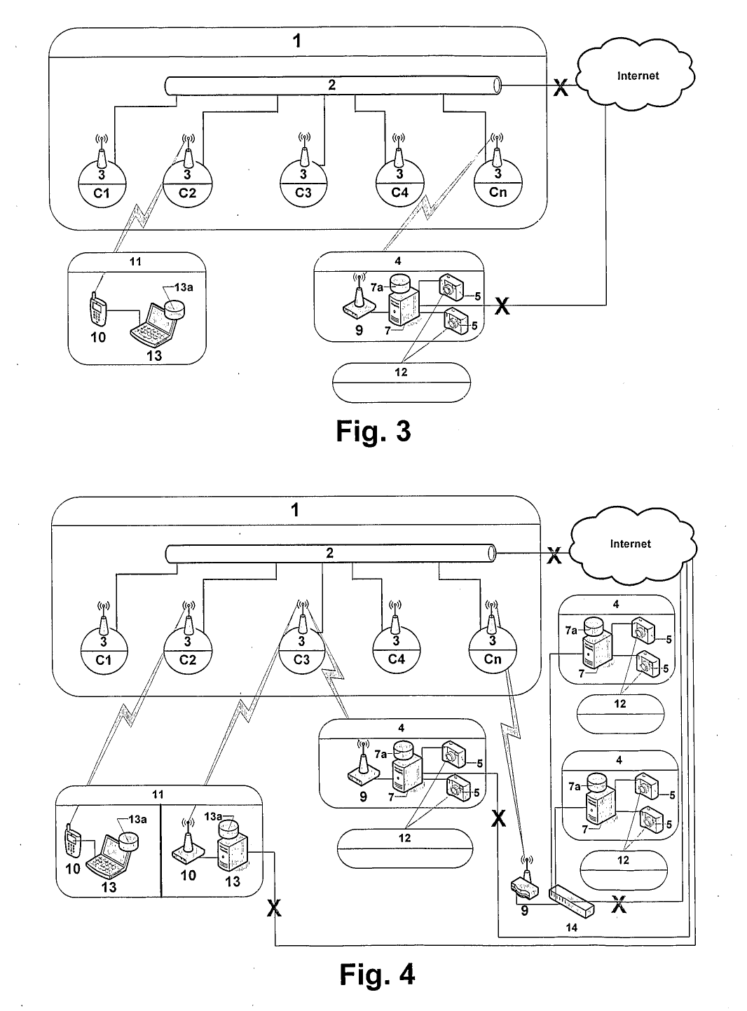

On FIG. 3 is shown an embodiment, wherein the controlling device for communications 10 is connected to the computer 13. In this case the computer 13 is portable. This embodiment allows for the data in addition to the disk storage 7a of the computer 7 of the local system 4 to be saved also on a disk storage 13a of the computer 13, which significantly improves the reliability of the system. Here again the private computer network 2 of the mobile operator and the computer system 7 of the local system for monitoring 4 are not connected to Internet.

On FIG. 4 is shown an expanded embodiment of the present invention, where more than one systems are shown, in this case three, local systems for monitoring 4 of various objects, which could be monitored and controlled from at least one monitoring object 11. In this case two local systems 4 for monitoring of two different objects 12 are connected in a local network through a switch 14, which is connected to one controlled mobile device for communication 9. In one preferred embodiment the mobile device 9 is 3G router. In this case there is not a link to Internet as well.

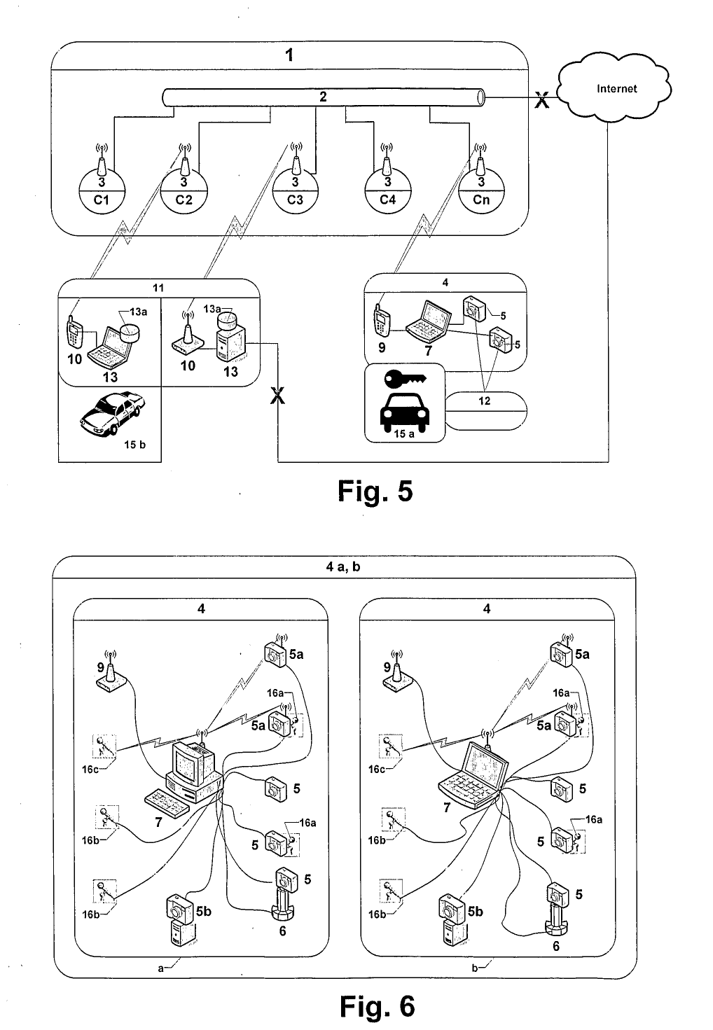

On FIG. 5 is illustrated an embodiment of the described system, where the local monitoring system 4 is installed in a vehicle 15a. In this case, it is shown that, it is a land vehicle, however it could be any other like airplane, ship or a submerging vessel. In this example, it is shown, that the monitored objects 11 could be more than one, in this case they are two. The example illustrates, that a monitoring object 11 could also be installed on a vehicle 15b. In this case there is no link to Internet as well.

On FIGS. 6a and 6b are shown two extended embodiments of a local monitoring system 4. FIG. 6a illustrates the use of desktop computer 7, while FIG. 6b shows the use of portable computer 7. The video cameras 5 could be stationary, as well as wireless 5a, or with a system for control 6, or IP cameras 5b. When required with any of the local systems 4 a microphone could be included, built-in 16a and/or external 16b and/or wireless 16c. In the embodiments using IP cameras 5b switched directly to the router 9 the use of computers is avoided. This is a preferred embodiment when the local monitoring system 4 in a vehicle 15a, since the need from a power supply is eliminated.

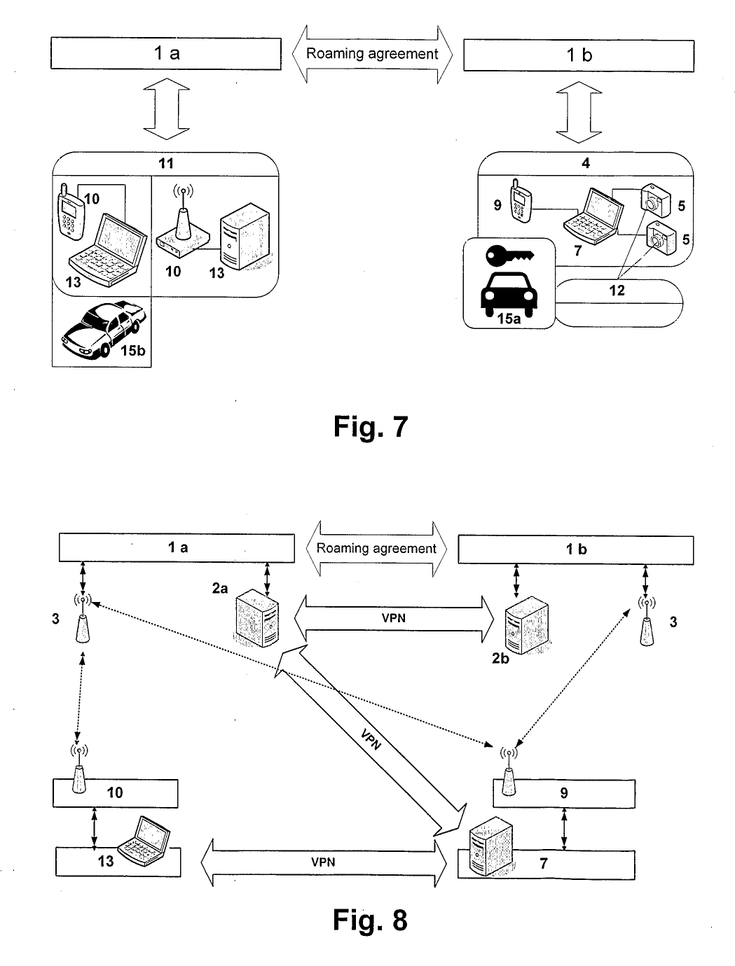

If it is necessary, when it is required to trace given monitored object outside the range of the license of the mobile operator, as well as when the monitoring object is outside of this range, the system, as shown on FIG. 7, allows the use of mobile operator's roaming service.

When increased security is required one could build various Virtual Private Network (VPN) links, as shown on FIG. 8. On this figure are shown two mobile operators 1a and 1b, which are connected through a VPN link between the computer networks 2a and 2b. Another VPN link could be established between the computer network 2 of the mobile operator and the computer system 7 of the local system 4 for monitoring. A third possible embodiment is shown, where the VPN link is between computer 13 of the controlling mobile device for communication 10 and the computer system 7 of the local system 4 for monitoring.

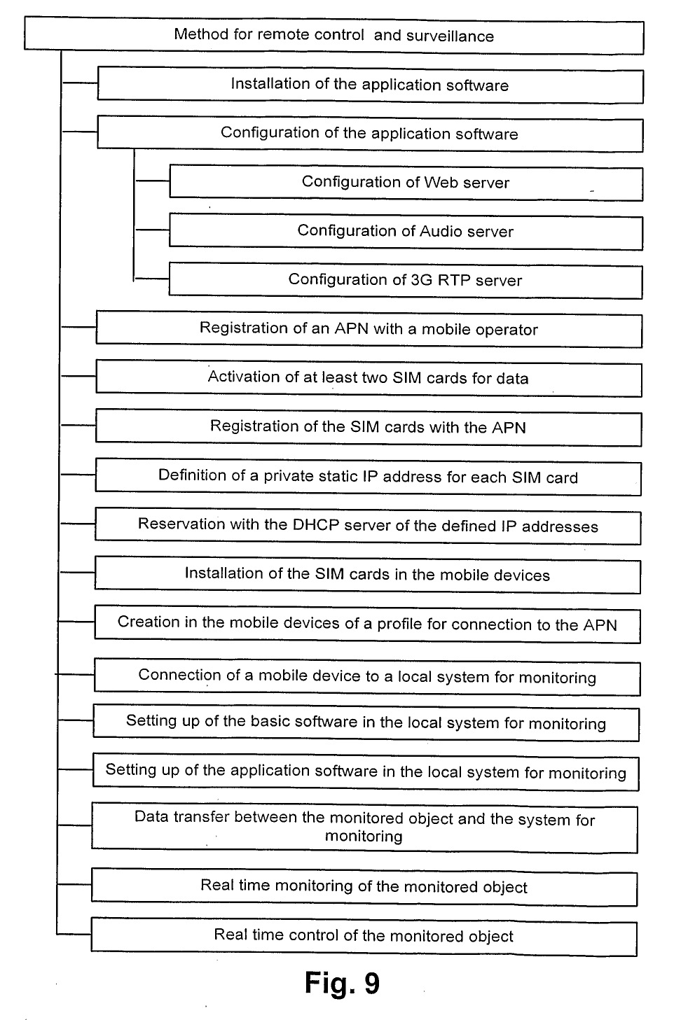

On FIG. 9 is shown the algorithm of the method of the present invention, in accordance with which operate the systems on FIGS. 2 to 5. Based on the method, the mobile operator is establishing a private wireless network with high-speed access, for example GPRS, 3G and others alike, and registers an APN name, for example video.monitoring.bg. With the mobile operator are activated at least two SIM cards for use with a high-speed wireless access, for example GPRS, 3G and others alike. The SIM cards are registered for use with that APN. The mobile operator defines private IP addresses for every SIM card. For example, the first SIM card always gets a private IP address 10.10.10.30, while the second SIM card will always get the private IP address 10.10.10.40. The mobile operator configures the DHCP (Dynamic Host Configuration Protocol) server for the reservations already made of the private IP addresses. The SIM cards are placed in the mobile devices (modems, mobile phones and etc.), through which the connection must be implemented to improve security. In every mobile device according to the model are made the necessary specific settings (APN name and etc.) for access to the registered by the mobile operator private network. To the local computer system 4, for video monitoring, is plugged in a controlled mobile communication device 9, for example a VMC modem. In the operating system of the computer 4 are made the necessary settings for registration of the mobile device 9 as a network device, such as installation of drivers, creation of a network connection on demand, etc. The first SIM card is placed In the mobile device 9 and a profile for use of APN is created, for example with a name video.monitoring.bg. The link to the mobile operator is established and the personal computer gets from the operator's DHCP server an IP address, for example 10.10.10.30. Standard software is installed on the local system for video monitoring. The settings of the application software are made, for example the web server to respond to IP address 10.10.10.30. In the application's software white list, not shown on FIG. 9, the IP address is added, for example 10.10.10.40, i.e. only from this address the video monitoring and control with the monitored object 11 is allowed. It is possible to add all private IP addresses, from which it is permitted to implement video monitoring and control. A name and password are set for access to the web page. In the controlling mobile device 10, for example mobile smart phone, the second SIM card is placed. In device 10, if required, a new profile is created with the required settings for connection to the network of the mobile operator for use of an APN with a name video.monitoring.bg. It is set that when using the web browser to use this profile. If it is desired, video monitoring and/or control in the mobile telephone 10, the browser is called by showing web page http://10.10.10.30. To open the web page the user's name and password must be entered, as they have been set-up in the web server, after that the desired objects for monitoring or control are selected.

The creation of a separate profile at the mobile phone allows its owner, if desired, to use other services of the mobile operator, but by using another connection profile.

The method is tested and the tests have been done with systems of GeoVision Inc. To operate using this method are suitable all available on the market high speed mobile devices (operating according to the standards GPRS, EDGE, UMTS [symbol] HSDPA). The tests have been made with a Siemens MC35i Terminal, VMCC and VMCM.

In addition to the algorithm described above, additional application software could be installed, not shown in the figures, in which events could be defined in advance, where the monitoring object must be notified. For example, when the SMS server is switched on, in the monitored system, are defined critical situations for which the system must automatically inform the monitoring object with a SMS and it could initiate video monitoring or control of the local system 4. According to one embodiment of the invention after the monitoring is completed the communication is interrupted by the mobile phone 10, while at the local system 4 end, for video monitoring, the link is maintained 24 hours×7 days a week with the objective to be always available for monitoring.

The present invention is represented by sample embodiments only, which do not serve to limit the inventor's idea, but are only for illustration, and the scope of the invention is defined by the claims.

1. Mobile system for remote control and viewing of objects, comprising:
a connection system, which includes a network of at least one mobile operator;
a local computer system for monitoring, linked to the connection system; and
communication devices for data transfer between at least one monitored object and at least one monitoring object also linked to the connection system;
wherein the local monitoring system includes at least one video camera for monitoring with capabilities for control and/or configuring by a computer, as well as at least one computer connected to the video camera,
wherein the control devices for communications include controlling devices for communications at the monitored object and controlled devices for communications at the monitored object,
wherein the controlling devices for communication are connected to the network of a mobile operator, and
wherein:
the connection system is built from a private computer and cellular network of one mobile operator;
the system of the mobile operator is capable of registering an Access Point Name;
the system of the mobile operator has a Dynamic Host Configuration Protocol server with capability for reserving private IP addresses for a registered SIM cards;
the private IP addresses are static;
the controlling devices for communications comprise at least one mobile device with a SIM card with a capability to operate with a rate of at least 84 Kbps;
at least one of the controlling devices for communication is capable of receiving data from controlled mobile device, connected to the computer of the video camera for monitoring of the object;
the controlled devices for communications are at least one mobile device with a SIM card capable of operating with at least 84 Kbps;
at least one of the controlled mobile devices for communications is connected to at least one computer of a video camera at the monitored object with capabilities for data transfer;

2. The Mobile system, according to claim 1, wherein, at least one of the controlling mobile devices for communications with a SIM card is a mobile smart phone.

3. Mobile system, according to claim 1, wherein, the controlling mobile device for communication of at least one controlling object is connected to a computer.

4. Mobile system, according to claim 3, wherein, the computer is portable.

5. Mobile system, according to claim 1, wherein, at least one controlled mobile device is connected to at least two computers of video cameras.

6. Mobile system, according to claim 1, wherein, the video cameras are IP cameras.

7. Mobile system, according to claim 1, wherein, the controlled mobile device is 3G router.

8. Mobile systems, according to claim 1, wherein, at least one video camera is installed in a vehicle.

9. Mobile system, according to claim 1, wherein, between the communication devices is established a Virtual Private Network.

10. Mobile system, according to claim 1, wherein, the local system for monitoring includes a microphone.

11. Mobile system, according to claim 10, wherein, the microphone is built-in the video camera.

12. Mobile system, according to claim 1, wherein, at least one controlling mobile device in the controlling object has a capability for data storage in the computer and/or with a capability for remote control of the data storage in computer of at least one local monitoring system.

13. Mobile system, according to claim 1, wherein, the video camera has built-in computer.

14. Method for remote control of objects, comprising:
installation and configuration of application software in communication devices controlled at least through one local computer system for audio and/or video monitoring where the software provides for local and remote audio and/or visual monitoring of at least one monitored object, connecting of control devices for communications to the network of a mobile operator; data transfer between the control devices for communication of the controlled object and the controlling devices for communication of the controlling object; as well as real time remote monitoring and control of the monitored object, wherein,
the controlled devices for communication and the controlling devices for communication connect to a private computer and cellular network of one mobile operator;
before the transfer of data and remote monitoring and control, a registration is made with the mobile operator of an Access Point Name (APN) of a private network for wireless access; activation with the mobile operator of at least two SIM cards for data transfer, registration with the mobile operator of the activated SIM cards for use with the registered APN; the mobile operator defines static private IP addresses for each SIM card registered with the APN; reservation with the Dynamic Host Configuration Protocol (DHCP) server of the mobile operator of the predefined IP addresses; placing each SIM card in one mobile device and creating of a profile for connection to the registered APN with the mobile operator; linking to at least one local network of a mobile device for communication; setting of the system and application software of the local system for wireless connection to a private APN network of the mobile operator.

15. Method for remote control according to claim 14, wherein, the mobile operator registers the APN name with at least one other mobile operator, with which it has a signed contract for roaming.

16. Method for remote control, according to claim 14, wherein, in the application software of the local monitoring system a white list is created, where all private IP addresses are included, from which audio and/or video monitoring and control is allowed of the monitored object.

17. Method for remote control, according to claim 14, wherein, the local computer system for monitoring is continuously connected to the network of the mobile operator.

18. Method for remote control, according to claim 14, wherein, the local computer system of the control devices notifies at least one controlling object about predefined events in the application software
